(19) United States
(12) Patent Application Publication
(10) Pub. No.: US 2004/0258265 A1
(43) Pub. Date: Dec. 23, 2004

(54) Portable lock-down listening display station

(76) Inventor: Mark Cordova, Las Vegas, NV (US)

Correspondence Address: Mark Cordova, 329 Wisteria Ave., Las Vegas, NV, 89107, US

(21) Appl. No.: 10/864,968

(22) Filed: Jun. 10, 2004

Related U.S. Application Data
(60) Provisional application No. 60/480,555, filed on Jun. 19, 2003.

(51) Int. Cl. H04R 1/02; H04R 9/06

(52) U.S. Cl. 381/334; 381/87; 381/386

(57) ABSTRACT

A portable, confinable, containment device with a displayable backboard 10 having the ability to be secured by means of a chain or a cable 27 to any solid and stable structure containing within itself any audio playing machine such as a portable compact disc player 17 enabling one to manually adjust and change settings of said audio playing machine while listening to audio sound by use of headphones 18 or audio speakers. In conjunction with said portable, confinable, containment device not allowing one to retract said audio playing machine or its components from said portable, confinable, containment device which has the ability to confine and contain said audio playing machine securely within itself by the use of a locking device 23 and 24.

### CROSS REFERENCE TO RELATED APPLICATIONS

This Application claims the benefit of Provisional patent application Ser. No. 60/480,555 filed Jun. 19, 2003 by the present inventor

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to portable listening display stations, specifically to secure portable CD players within such portable listening display stations using a locking device and a cable or chain to lock and secure the whole station to any solid and stable structure.

### BACKGROUND OF THE INVENTION

Independent music producers have a hard time promoting their music to the public. Acquiring airplay from radio stations or obtaining the ability to sell music through retail music stores is extremely difficult. However a Portable Lock-Down Listening Display Station enables one to promote one's music anywhere one wants or is able to.

Stores that sell audio music to the public such as compact discs that are commonly referred to as CD's do have Listening Display Stations.

a) These Listening Display Stations are extremely expensive.

b) Some are only Listening Stations

c) Some display only the name of the CD's that one is allowed to listen to.

d) None of these Listening Display Stations are portable.

### BACKGROUND OF THE INVENTION—OBJECTS AND ADVANTAGES

Of the Portable Lock-down Listening Display Station, here are some objects and advantages. Here, the Portable Lock-down Listening Display Station will be referred to as the unit.

a) The unit can be manufactured inexpensively. Therefore is affordable to the public. Accordingly, Independent Music Producers and Artists may obtain one for less than two hundred dollars at the present time. Also, smaller music stores or stores referred to as “Mom & Pop” stores who normally could not afford the outrageous expensive Listening Display Station (that the big corporate music stores have), could easily afford this unit.

b) The unit is lightweight and portable, and therefore has a great advantage. It may be used in a number of different ways to promote and sell music.

c) a very important reason. It utilizes the ability to lock within itself a portable CD player. It also has the ability to be locked and secured to any stable structure, thus affording security from theft or vandalism.

d) Also provided are security cables for headphones keeping them safe and protected.

e) A promotional backboard being part of the unit gives the owner the ability to use any type of promotion desired. Be it a poster, sleeves from a CD case, pictures, or any type of advertisement. These illustrations will give the listener an idea of what he or she is listening to.

The Portable Lock-down Listening Display Station gives an opportunity and provides a means for the Independent Music Producer and Artist to get their music heard without the help of a radio station and sold without the help of a record store.

### SUMMARY

The invention, a Portable Lock-Down Listening Display Station that locks and secures not only a portable CD player within it, but also, the Portable Lock-Down Listening Display Station itself, can be locked and secured to any solid and stable structure. Accordingly the invention is intended to provide a means for any person to promote music or anything else that can be played and listened to by using a CD player, with the comfort of knowing that their CD player and headphones are safe and secure.

### DRAWINGS—FIGURES

FIG. 1 is a perspective frontal view of a Portable Lock-Down Listening Display Station constructed in accordance with the invention, showing the front of the unit from top to bottom.

FIG. 2 is a perspective front angled view of a Portable Lock-Down Listening Display Station unlocked and opened without a portable CD player or headphones.

FIG. 3 is a perspective front angled view of a Portable Lock-Down Listening Display Station unlocked and opened showing portable CD player and headphones in their proper position.

FIG. 4 is a perspective backside angled view of a Portable Lock-Down Listening Display Station showing lock & key, lock-down cable, chain hole, and power cord.

FIG. 5 is a perspective close up view of a Portable Lock-Down Listening Display Station unlocked and opened showing internal structure.

### DRAWINGS—REFERENCE NUMERALS

10 display board

11 hanging posts (for headphones)

12 hole for chain

13 cutout window (for CD player 17)

14 hinge

15 cover lid

16 protective cables (for headphones 18)

17 CD player

18 headphones

19 base container

20 holes (for cables 16 and headphone cords)

21 mount (for CD player 17)

22 velcro

23 lock & key

24 catch (for lock 23)

25 hole (for power cord 28)

26 hole (for lock-down cable 27)

27 lock-down cable

28 power cord

29 bolts (connecting display board 10 to base container 19)

30 bolts (connecting cover lid 15, hinge 14 and base container 19)

### DETAILED DESCRIPTION

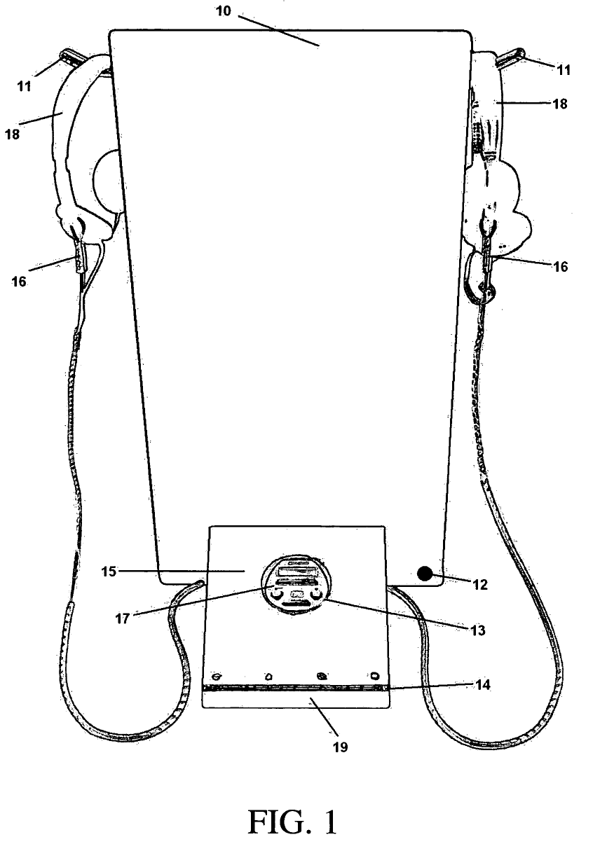

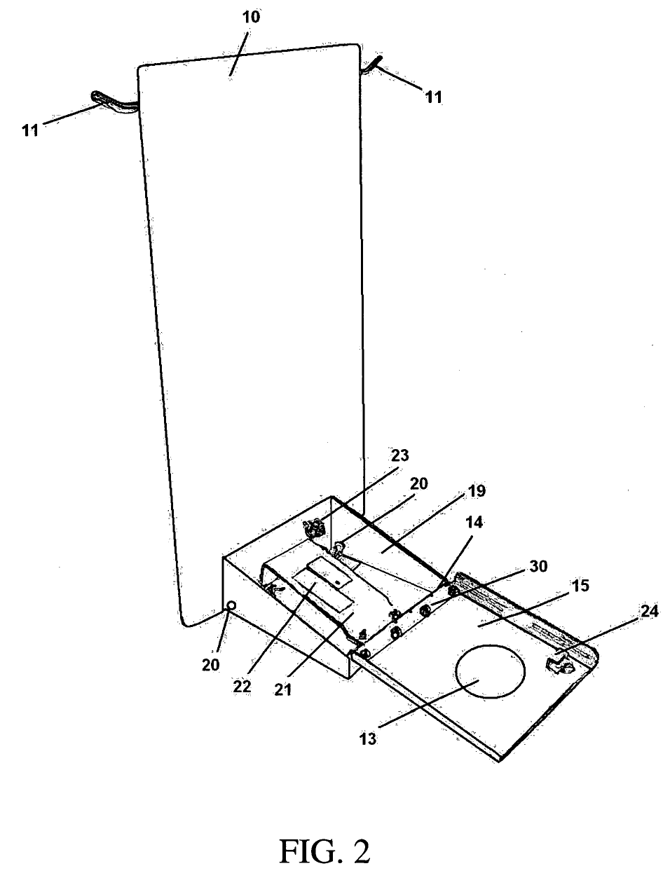

FIG. 1 is a perspective frontal view of a Portable Lock-Down Listening Display Station constructed in accordance with the invention. The upper back portion referred to as the display board 10 is the display part of the unit. The whole area of the display board 10 is used for promotion with two hanging posts 11 for headphones 18 which are mounted on top left and right corners of the display board 10. 12 is a hole sized that one may install a chain to lock-down and secure the whole unit to any solid and stable structure. 13 is the custom made cutout window to be shaped and to fit many different types of portable CD players.14 is a hinge or hinges or any other means of attaching 15 called in this description the cover lid to 19 referred to as the base container. 16 refers to two durable cables that attach to the base container 19 through holes 20 not shown in FIG. 1, but shown in FIGS. 2, 3 and 5. The cables 16 are attached also to headphones 18. The cables 16 are sized to be some what shorter than the headphone cords so as to protect headphone cords from pulling, yanking or theft.17 is a portable CD player shown through cutout window 13 safely locked inside the Portable Lock-Down Listening Display Station.

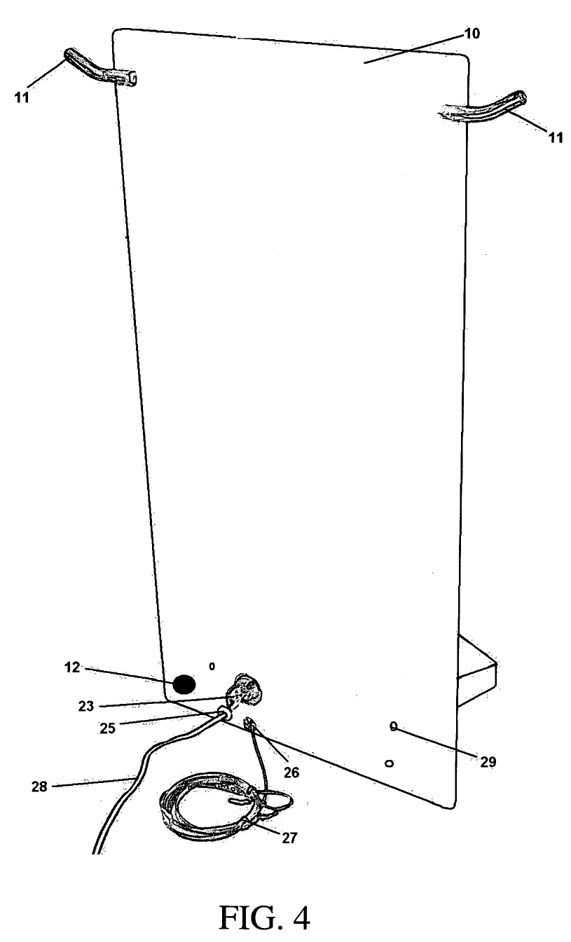

FIG. 2 is a perspective front angled view of a Portable Lock-Down Listening Display Station unlocked and opened without a portable CD player 17 or headphones 18. In this figure the cover lid 15 is shown swung all the way open exposing the internal structure of the unit. A hinge 14 attaches the cover lid 15 and the base container 19 together enabling the cover lid 15 to swing open or closed. In this illustration bolts 30 are shown to be used to attach cover lid 15, hinge 14 and base container 19 together. Positioned are the holes 20 to attach cables 16. Cables 16 are not shown in FIG. 2 but are shown in FIGS. 1, 3 and 5. An inside view of custom made cutout window is shown as 13. A mount shown as 21 is attached to the base container 19 using four bolts. A CD player 17 not shown in this figure sits on top of mount 21 and is stabilized using Velcro 22. The inner part of the lock 23 corresponds with the catch 24. When the cover lid is closed, a key to be shown in FIG. 4 is turned to lock 23 the lock to the catch 24 securing the cover lid 15 to the base container 19 preventing the Portable Lock-Down Listening Display Station to be opened.

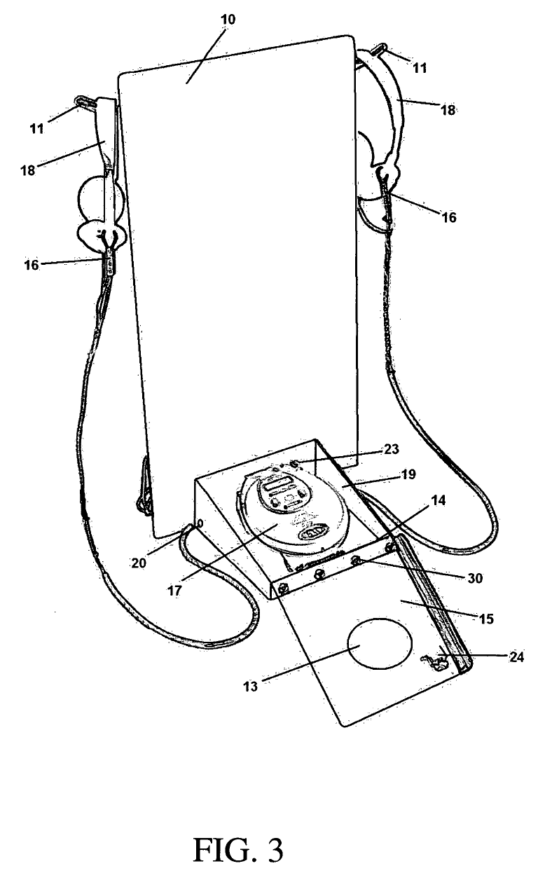

FIG. 3 is a perspective front angled view of a Portable Lock-Down Listening Display Station unlocked and opened with a portable CD player 17 and headphones 18 in there proper position. All details in this figure are the same as FIG. 1 and 2. This figure is to show how a portable CD player 17 fits inside the Portable Lock-Down Listening Display Station.

FIG. 4 is a perspective backside angled view of a Portable Lock-down Listening Display Station showing lock and key 23, lock-down cable 27, chain holes 12, and power cord 28. The lock and key 23 are shown in this figure on the backside of the unit. The lock 23 is connected to the unit bolted from the inside of the base container 19 through the outside of the display board 10. The key 23 can be removed after the unit is locked preventing it from being opened. A hole 26 is used to attach the lock-down cable 27 which can be locked-down to any solid and stable structure, keeping the unit safe from theft. A hole 25 is for power cord 28. 29 illustrates the areas where bolts are used to attach the display board 10 to the base container 19.

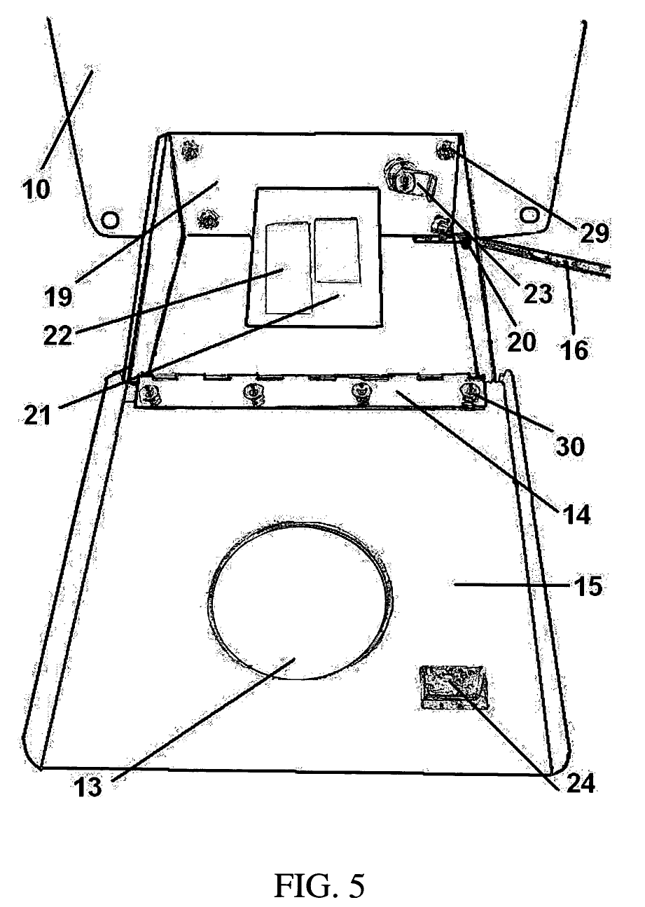

FIG. 5 is a perspective close-up view of a Portable Lock-Down Listening Display Station, unlocked and open showing the internal structure. This figure is to show a more detailed view of how the lock 23 and catch 24 correspond.

Operation

In operation one uses the Portable Lock-Down Listening Display Station to promote anything that can be played and listened to by a portable compact disc player and headphones.

(1) Installation is simple, with the unit unlocked and the cover lid 15 swung open, one places desired CD player 17 on top of the mount 21 using Velcro 22. The Velcro 22 is attached to the mount 21 and to the back of the CD player 17.

(2) After placing the CD player 17 on top of the mount 21 the headphone cords, part of 18 are inserted into the base container 19 through holes 20 on either side. After the headphone cords have been inserted, one simply connects them into their proper place on the CD player 17. (Most CD players come with one set of headphones, if one desires to use two sets; one will need to purchase an adapter that will splice them together).

(3) At this point the protective cables 16 are attached to the headphones 18 illustrated on FIGS. 2 and 3 using crimping beads for cable. The headphone cords may be bound to the protective cables 16 using tape or any other desired means. (In FIGS. 1 and 3 a plastic covering is used). At this point headphones 18 may be hung safely from the hanging posts 11.

(4) The power cord 28 for the CD player 17 is inserted through a hole 25 located on the back of the unit. It is then plugged into the power input of the CD player 17 (See FIG. 4).

(5) At this point cover lid 15 may be closed and locked by turning a key that corresponds with a lock 23 on the back of the unit shown on FIG. 4. This lock 23 is then locked to the catch 24 which is connected to the inside of the cover lid 15 keeping the CD player 17 firmly inside the unit safe and secure from theft.

(6) Now, the Portable Lock-Down Listening Display Station can be used to promote material (anywhere one wishes to in accordance with the law). After a spot has been chosen one simply plugs in the power cord 28 to any AC or DC outlet to give power to the CD player 17. Then depending on the preference of security one may either use a chain by connecting to chain hole 12 that can then be chained to any solid and stable structure. Or one may use the provided lock-down cable 27 in the same manner. When the user has completed the operation the user may then use display board 10 to promote the users material. Once the unit is set up, anyone may now walk up to the unit, place the headphones 18 on their head, listen to the music or what ever else is being promoted. Because of the cutout window 13, anyone may change to any desired tracks of the CD being listened to at any time.

Advantages

From the description above, evident advantages of the Portable Lock-Down Listening Display Station are:

a)That the unit is inexpensive and easy to make.

b)The unit is portable, enabling one to setup and display one or more units in various places allowing many different means of promotion.

c)The unit has the ability to secure within itself a playable audio listening machine such as a compact disc player, by means of a simple locking device.

d)The whole unit can be locked and secured to any solid and stable structure.

e)The unit has a displayable backboard for illustration of what is being played and also to advertise and promote.

f) The unit obtains cables to protect from damage and secure from theft the headphones being used.

Conclusion, Ramification, and Scope

Accordingly, any reader can see that this invention the Portable Lock-Down Listening Display Station can be the best if not the only means of promoting and selling music for the independent artist and music producer. There are so many great writers, great music producers, and so many great songs, that without this new invention they will never be heard of or listened to. Reason being, that writers, producers, artists and songs are not being accepted by the music industry. Not because of the lack of talent but rather the industry is more concerned with marketing visual concepts and products pertaining to artists, such as dolls, posters, cards and toys. The industry also spends big on videos. Because of all these other concerns, the amount of concern put into the actual music is lacking. In conclusion, this invention can enable true talent to find its place in the world, and give the consumer a broader selection of quality music.

The specifications of the description above should not be construed as limiting the scope of the invention but as merely providing illustrations of some of the presently preferred embodiments of this invention. For example: the base container, the backboard and cover lid can have other shapes; such as circular, oval, trapezoidal, triangular, etc.; the whole invention can be made of virtually any hard durable substance, such as metal, plastic, fiber glass, wood, etc.

Thus the scope of the invention should be determined by the appended claims and their legal equivalence, rather than by the examples given.

I claim:

1. A portable, confinable, containment device having a displayable backboard purposefully containing within itself any audio playing machine by means of a locking device thereby also having ability to be locked and unlocked as a whole to any solid and stable structure whereby enabling one to adjust settings of said audio playing machine by means of a cutout window while listening to audio sound.

2. A container having ability to confine within itself and to allow retraction from its chamber any audio playing machine by means of a locking and unlocking device, comprising:
a) means of opening and closing said container whereby having ability to place within and to retract from any said audio playing machine.
b) means of adjusting settings of any said audio playing machine from outside of said container while said audio playing machine is confined within said container.
c) means for workability of any said audio playing machine such as small openings positioned and cut through said container for through passage of electrical and audio cords.
d) a displayable backboard whereby being attached to and corresponding with said container.
e) means of locking and unlocking said container to any stable structure.
f) construction of any hard durable substance wherein said substance is colored.
g) portability

3. A portable containment device confining within itself any audio playing mechanism with means of being secured to and released from any stable structure whereby having ability that a human being may adjust settings of any said audio playing mechanism while listening to audio sound.
